(19) United States
(12) Patent Application Publication
(10) Pub. No.: US 2011/0194801 A1
(43) Pub. Date: Aug. 11, 2011

(54) OPTICAL DEVICE USING NEGATIVE GOOS-HANCHEN SHIFT

(75) Inventors: Young-Wan CHOI, Seoul (KR); Geum-Yoon OH, Seoul (KR); Doo-Gun KIM, Seoul (KR); Hong-Seung KIM, Seoul (KR)

(73) Assignee: CHUNG-ANG UNIVERSITY INDUSTRY-ACADEMY COOPERATION FOUNDATION, Seoul (KR)

(21) Appl. No.: 12/904,328

(22) Filed: Oct. 14, 2010

(30) Foreign Application Priority Data
Feb. 5, 2010 (KR) 10-2010-0010712

(51) Int. Cl. G02F 1/035; G02B 6/10

(52) U.S. Cl. 385/3; 385/131

(57) ABSTRACT

Provided is an optical device delaying light by using negative Goos-Hanchen shift. The optical device includes an optical waveguide adapted to guide and emit an incident light, a first reflection layer disposed at one side of the optical waveguide, and a second reflection layer disposed at the other side of the optical waveguide. At least one of the first and the second reflection layers is made of a material having characteristics of negative Goos-Hanchen shift.

### CROSS-REFERENCE TO RELATED APPLICATION

This application claims priority to Korean Patent Application No. 10-2010-0010712 filed on Feb. 5, 2010 and all the benefits accruing therefrom under 35 U.S.C. §119, the contents of which are incorporated by reference in their entirety.

### BACKGROUND

The present disclosure relates to an optical device, and more particularly, to an optical device capable of delaying light by using negative Goos-Hanchen shift.

With the development of computers and information appliances, the amount of information is increasing in geometric progression. Thus, information is already overflowing by rapidly increasing beyond the present development speed of technologies, such as electric communication networks, computers, and so forth. To this end, there is demanded an improved communication technology for processing more information more quickly. Light, differently from an electromagnetic wave, is capable of parallel information processing since it is not subject to electromagnetic wave interference. Technologies are now being developed in relation to optical computers and optical network using optical devices even faster than electronic devices. Also, researches for various optical devices are in active progress.

Light travels through a medium at a high speed of about 300,000 km/sec. Since light is used as a medium for transmitting signals in an optical circuit, the signal transmission rate is almost equal to the velocity of light. In designing the circuit, variation of the signal transmission rate may be required according to a circuit designer's need. However, an optical delay device according to the related art is incapable of delaying light by as much as desired. Furthermore, the related-art optical delay device is capable of the delay by no more than tens of nanoseconds (ns). Accordingly, researches have been performed for an optical delay device capable of not only controlling a degree of delay of light but also considerably increasing the delay degree.

Such researches have introduced a phase adjusting method using an interference modulator, a delay method using a ring resonator, a delay method using nonlinearity of a photonic crystal structure, and so forth. Especially, an optical delay device using the photonic crystal structure are being actively studied.

The optical delay device using the photonic crystal structure constructs a photonic crystal waveguide to obtain a low group velocity of light in consideration of influences of a frequency bandwidth and higher-order dispersion. According to a dispersion curve of the photonic crystal waveguide, there is a region showing nonlinear dispersion characteristic among a plurality of dispersion curves of light passing through a core and cladding. The optical delay device having slow light group velocity is achieved using the above principle. However, the photonic crystal waveguide requires very complicated manufacturing processes. Furthermore, it is difficult to adjust delay characteristics of the optical delay device once manufactured.

### SUMMARY

The present disclosure provides an optical device capable of delaying light by using negative Goos-Hanchen shift.

According to an exemplary embodiment, optical device using negative Goos-Hanchen shift, including an optical waveguide adapted to guide and emit an incident light; a first reflection layer disposed at one side of the optical waveguide; and a second reflection layer disposed at the other side of the optical waveguide, wherein at least one of the first and the second reflection layers is made of a material having characteristics of negative Goos-Hanchen shift.

The material having characteristics of negative Goos-Hanchen shift may be noble metal.

At least one of the first and the second reflection layers made of the material having negative Goos-Hanchen shift characteristics may include a pattern formed on a surface thereof facing the optical waveguide. The pattern may be a line pattern comprising unevenness in the form of periodic lines arranged perpendicular to light traveling in the optical waveguide.

The optical waveguide may be made of a material of which refractive index is varied according to variation of an electric field. The optical waveguide may include a II-VI compound semiconductor such as cadmium telluride (CdTe).

The optical device may further include an electric field applying unit adapted to apply an electric field to the optical waveguide, thereby adjusting light traveling through the optical waveguide.

### BRIEF DESCRIPTION OF THE DRAWINGS

Exemplary embodiments can be understood in more detail from the following description taken in conjunction with the accompanying drawings, in which:

FIGS. 1A and 1B are views for explaining Goos-Hanchen shift;

FIG. 2 is a view schematically showing an optical device according to an embodiment; and

FIG. 3 is a schematic view illustrating an example of a reflection layer provided in the optical device according to the embodiment.

### DETAILED DESCRIPTION OF EMBODIMENTS

The present disclosure relates to an optical device using negative Goos-Hanchen shift. Goos-Hanchen shift will be described prior to the optical device.

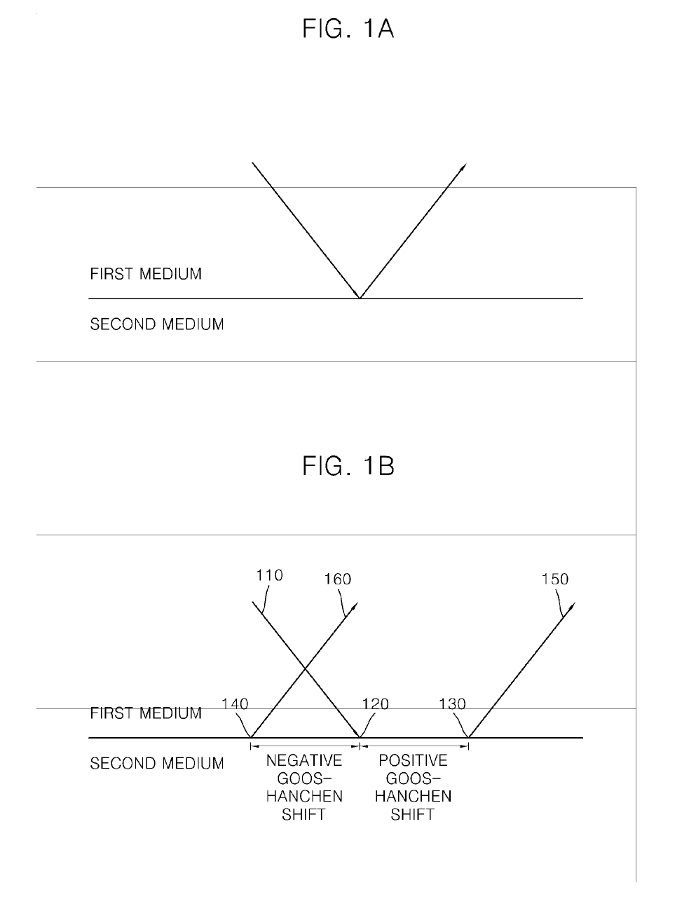

FIGS. 1A and 1B are views for explaining the Goos-Hanchen shift.

As shown in FIG. 1A, when light traveling through a first medium meets a second medium having a different refractive index from the first medium, the light reflects from an interface between the first medium and the second medium. Here, a point where an incident light reflects may not correspond to a point where the incident light meets the interface between the first and the second mediums.

To be more specific, as shown in FIG. 1B, a point at which incident light 110 is reflected may be located more anterior or posterior than a point 120 at which the incident light meets the interface between the first and the second mediums. That is, the reflected lights 150 and 160 may travel from the anterior point 130 or the posterior point 140 to the light incidence point 120, which is called the Goos-Hanchen effect. Distances from the point 120 where the incident light meets the interface respectively to the anterior point 130 and the posterior point 140 from which the reflected light travels are called Goos-Hanchen shifts. When the reflected light 150 travels from the anterior point 130, the distance is referred to as a positive Goos-Hanchen shift. When the reflected light 160 travels from the posterior point 140, the distance is referred to as a negative Goos-Hanchen shift.

Whether the Gooso-Hanchen shift of the light will occur in the positive direction or the negative direction is determined by the second medium. Typically, noble metal such as gold (Au) and silver (Ag) has characteristics of the negative Goos-Hanchen shift. In addition, a degree of the Goos-Hanchen shift may be varied not only by the material of the second medium but also by a wavelength of the incident light, an incidence angle, and a surface profile of the second medium.

Hereinafter, an optical device using the negative Goos-Hanchen shift according to an exemplary embodiment will be described in detail with reference to the accompanying drawings. The present disclosure may, however, be embodied in different forms and should not be construed as limited to the following embodiments set forth herein. Rather, these embodiments are provided so that this disclosure will be thorough and complete, and will fully convey the scope of the present invention to those skilled in the art.

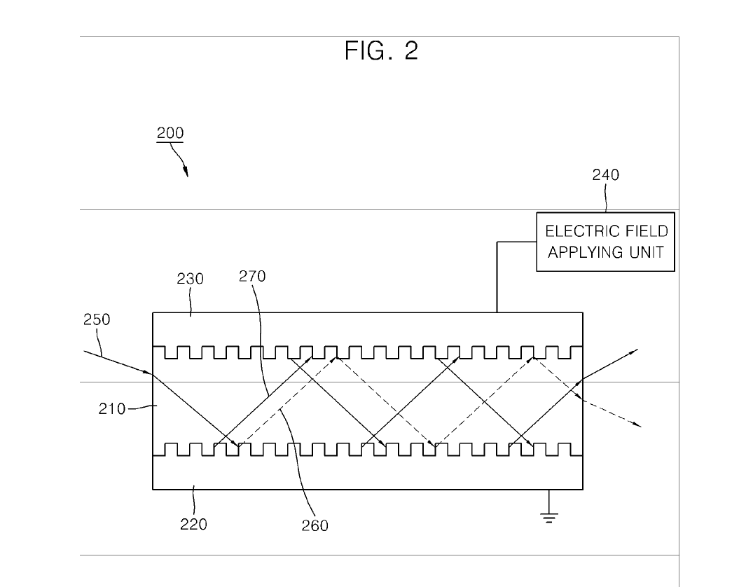

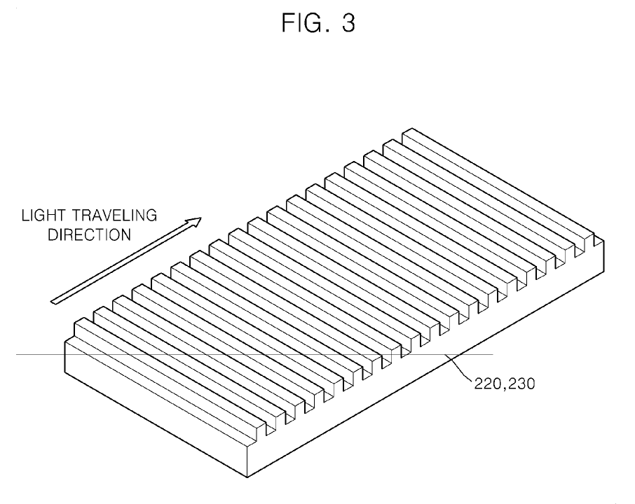

FIG. 2 is a view schematically showing an optical device according to an embodiment and FIG. 3 is a schematic view illustrating an example of a reflection layer provided in the optical device according to the embodiment.

Referring to FIGS. 2 and 3, an optical device 200 according to the embodiment includes an optical waveguide 210, a first reflection layer 220, a second reflection layer 230, and an electric field application unit 240.

The optical waveguide 210 guides light being inwardly incident and emits the light outward. The optical waveguide 210 may be formed of a material which varies in refractive index according to variation of an electric field. It is exemplary that the optical waveguide 210 is formed of a large kerr-constant material so that the refractive index is relatively greatly varied by variation of an outside electric field. In the case where the optical waveguide 210 is formed of a material of which the refractive index varies according to variation of an electric field, when an electric field is applied from the outside, the group velocity of light traveling within the optical waveguide 210 may be adjusted by variation of the refractive index according to the electro-optic effect. Accordingly, it becomes convenient to adjust the group velocity of the light traveling within the optical waveguide 210. Especially when the material of the optical waveguide 210 has a large ken-constant, adjustment of the light group velocity is easier. To this end, the optical waveguide 210 may include a II-VI compound semiconductor, and more exemplary, may include cadmium telluride (CdTe).

The first reflection layer 220 and the second reflection layer 230 may be disposed at one end and the other end of the optical waveguide 210, respectively, to reflect the light traveling within the optical waveguide 210. At least one of the first and the second reflection layers 220 and 230 has the characteristics of the negative Goos-Hanchen shift. In the present embodiment, both the first and the second reflection layers 220 and 230 have the characteristics of the negative Goos-Hanchen shift. For this, the first and the second reflection layers 220 and 230 may be made of noble metal such as Au and Ag.

The first and the second reflection layers 220 and 230 may each include a pattern formed on a surface thereof facing the optical waveguide 210 to increase the negative Goos-Hanchen shift. Here, the pattern refers to a structure having unevenness on one surface, such as a grating. The patterns of the first and the second reflection layers 220 and 230 may be a line pattern constituted by linear prominences and depressions periodically arranged as shown in FIG. 3. Exemplarily, respective lines of the line pattern are arranged perpendicular to the light traveling direction so that the negative Goos-Hanchen shift increases. The Goos-Hanchen shift may be adjusted by the wavelength of the incident light, the incidence angle, and the surface shape of the pattern. Here, it is exemplary that the pattern is a line pattern. In this case, the negative Goos-Hanchen shift may be adjusted by adjusting height of the unevenness of the line pattern.

As described above, when the first and the second reflection layers 220 and 230 are made of materials having the characteristics of the negative Goos-Hanchen shift, the group velocity of the light traveling within the optical waveguide 210 may be reduced. For example, in the case where light is incident to the optical waveguide 210 as illustrated by a reference numeral 250 in FIG. 2, if the first and the second reflection layers 220 and 230 are formed of a material not having the negative Goos-Hanchen shift characteristics, the light would travel through the optical waveguide 210 as shown by a dotted line 260. However, if the first and the second reflection layers 220 and 230 are formed of a material having the negative Goos-Hanchen shift characteristics, the light would travel as shown by a solid line 270. In other words, when the first and the second reflection layers 220 and 230 are formed of the material having the negative Goos-Hanchen characteristics, the light reflects from a posterior point than when not. Accordingly, the entire light path increases. As a result, the group velocity of the light traveling through the optical waveguide 210 may be reduced.

The electric field application unit 240 applies an electric field to the optical waveguide 210 to thereby vary the refractive index of the optical waveguide 210. Since the first and the second reflection layers 220 and 230 are both made of metal, the electric field application unit 240 is able to apply the electric filed to the optical waveguide 210 with a simple structure. By varying the refractive index of the optical waveguide 210 using the electric field, the group velocity of the light may be adjusted according to the electro-optic effect as described above. In addition, the degree of the negative Goos-Hanchen shift may be adjusted through variation of the refractive index of the optical waveguide 210. That is, as an electric field is applied to the optical waveguide 210 by the electric field 240, the group velocity of the light traveling within the optical waveguide 210 may be adjusted.

Whereas a related-art optical delay device using a photonic crystal structure is incapable of adjusting the light group velocity after being manufactured, the optical device 200 according to the embodiment is capable of adjusting the light group velocity even after being manufactured by applying an electric field to the optical waveguide 210 by the electric field application unit 240. Furthermore, according to the optical device 200, the delay time of light may be considerably increased by adjusting the wavelength, the incidence angle, the pattern profile, intensity of the electric field, and so on. The optical device 200 may be applied as a optical delay device in an optical printed circuit board (OPCB), a photonic integrated circuit, and so on, and also as an optical network system, an optical communication system, and an optical computer system.

According to the embodiment, light passing through an optical waveguide may be delayed by providing a reflection layer made of a material having negative Goos-Hanchen shift characteristics on both sides of the optical waveguide. Particularly, the line patterns having the periodic uneven lines may be disposed on the reflection layer to obtain the Goos-Hanchen shift having a larger negative value. In addition, the optical waveguide may be formed of the material in which the refractive index is varied according to the variation of the electric field so that the group velocity of light can be adjusted.

Although the optical device using negative Goos-Hanchen shift has been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. An optical device, comprising:
an optical waveguide adapted to guide and emit an incident light;
a first reflection layer disposed at one side of the optical waveguide; and
a second reflection layer disposed at the other side of the optical waveguide,
wherein at least one of the first and the second reflection layers is made of a material having a characteristic of negative Goos-Hanchen shift.

2. The optical device of claim 1, wherein the material having characteristics of the negative Goos-Hanchen shift comprises noble metal.

3. The optical device of claim 1, wherein at least one of the first and the second reflection layers made of the material having the negative Goos-Hanchen shift characteristic comprises a pattern formed on a surface thereof facing the optical waveguide.

4. The optical device of claim 3, wherein the pattern is a line pattern comprising unevenness in the form of periodic lines arranged perpendicular to light traveling in the optical waveguide.

5. The optical device of claim 1, wherein the optical waveguide is made of a material of which a refractive index is varied according to variation of an electric field.

6. The optical device of claim 5, wherein the optical waveguide comprises a II-VI compound semiconductor.

7. The optical device of claim 6, wherein the II-VI compound semiconductor comprises cadmium telluride (CdTe).

8. The optical device of claim 1, further comprising an electric field applying unit adapted to apply an electric field to the optical waveguide.

9. The optical device of claim 8, wherein the electric field applying unit applies an electric filed to the optical waveguide, thereby adjusting light traveling through the optical waveguide.

10. The optical device of claim 2, wherein the optical waveguide is made of a material of which a refractive index is varied according to variation of an electric field.

11. The optical device of claim 10, wherein the optical waveguide comprises a II-VI compound semiconductor.

12. The optical device of claim 11, wherein the II-VI compound semiconductor comprises cadmium telluride (CdTe).

13. The optical device of claim 2, further comprising an electric field applying unit adapted to apply an electric field to the optical waveguide.

14. The optical device of claim 13, wherein the electric field applying unit applies an electric filed to the optical waveguide, thereby adjusting light traveling through the optical waveguide.

15. The optical device of claim 3, wherein the optical waveguide is made of a material of which a refractive index is varied according to variation of an electric field.

16. The optical device of claim 15, wherein the optical waveguide comprises a II-VI compound semiconductor.

17. The optical device of claim 16, wherein the II-VI compound semiconductor comprises cadmium telluride (CdTe).

18. The optical device of claim 3, further comprising an electric field applying unit adapted to apply an electric field to the optical waveguide.

19. The optical device of claim 18, wherein the electric field applying unit applies an electric filed to the optical waveguide, thereby adjusting light traveling through the optical waveguide.

20. The optical device of claim 4, wherein the optical waveguide is made of a material of which a refractive index is varied according to variation of an electric field.
